(19) United States
(12) Patent Application Publication
(10) Pub. No.: US 2014/0002669 A1
(43) Pub. Date: Jan. 2, 2014

(54) INFRARED IMAGE CAPTURE DEVICE

(71) Applicant: Kenta Sudo, Yokohama-shi (JP)

(72) Inventor: Kenta Sudo, Yokohama-shi (JP)

(21) Appl. No.: 14/005,272

(22) PCT Filed: Mar. 14, 2012
(86) PCT No.: PCT/JP2012/001767

§ 371 Date: Sep. 15, 2013

(30) Foreign Application Priority Data
Mar. 16, 2011 (JP) 2011-058478

(51) Int. Cl. H04N 5/33

(52) U.S. Cl. CPC H04N 5/33
USPC 348/164

(57) ABSTRACT

In an infrared image capture device, an infrared optical system (10) has an objective optical system (13) that includes a primary mirror (11) and an auxiliary mirror (12) disposed to face each other along an optical axis (AX), and forms an intermediate image of an object (not illustrated) by sequentially reflecting the infrared ray from the object using the primary mirror (11) and the auxiliary mirror (12), and a non-transmitting portion (12f) which does not transmit the infrared rays from the object exists in the center portion of the auxiliary mirror (12). The non-transmitting portion (12f) in the center portion of the auxiliary mirror (12) is formed in a concave surface which satisfies a following conditional expression (1): L/1.2<R<1.5L - - - (1), where R denotes the absolute value of the radius of curvature of the center portion of the auxiliary mirror (12) which corresponds to the non-transmitting portion (12f), and L denotes a distance from the intermediate image forming position to the center portion of the auxiliary mirror which corresponds to the non-transmitting portion.

### TECHNICAL FIELD

The present invention relates to an infrared image capture device.

### TECHNICAL BACKGROUND

An infrared image capture device that transforms an object, which cannot be seen with the naked eyes in darkness, into a visible image using infrared ray, is configured to match an exit pupil of an infrared optical system with a cold aperture, which is an aperture stop (aperture matching), so that an image with good S/N (signal-to-noise) ratio can be acquired. If a Cassegrain type optical system, configured by a primary mirror having an aperture in the center portion and an auxiliary mirror for directing infrared ray reflected by the primary mirror to the aperture of the primary mirror, is used for the infrared optical system, the infrared ray from an object reflected by the primary mirror becomes zonal luminous flux (tube-like state) due to the aperture of the primary mirror, therefore even if the aperture matching is performed, the S/N may deteriorate if infrared ray, which is not desirable for imaging, enters the center portion of the aperture. To solve this problem, various infrared image capture devices have been disclosed (e.g. see Patent Documents 1 and 2).

### PRIOR ARTS LIST

### Patent Document

Patent Document 1: Japanese laid-Open Patent Publication No. H10-206986 (A)
Patent Document 2: Japanese Laid-Open Patent Publication No. H9-113797 (A)

### SUMMARY OF THE INVENTION

### Problems to be Solved by the Invention

An infrared image capture device according to Patent Document 1 is configured such that infrared ray, which comes from an area other than an object and becomes a source of detection noise, is shielded by a central shielding unit formed in an aperture area of a cold aperture. In this case, the central shielding unit must also be cooled down to a temperature near the temperature of liquid nitrogen, along with the cold aperture as a matter of course. However the central shielding unit is installed in the aperture area of the cold aperture via thin arm portions in a special structure, hence it is difficult to cool the central shielding unit down to a same temperature as the peripheral area thereof, and attempting this may cause deterioration of the SiN of an acquired image.

In the case of the infrared image capture device according to Patent Document 2, this device prevents undesired infrared ray, to be a source of detection noise, from entering the center portion of the aperture and reaching a detector, by disposing an objective optical system for forming an immediate image and a re-imaging optical system which is located on the image side of the intermediate image to be decentered from each other. In the case of this configuration, however, the objective optical system requires an off-axis optical design, therefore aberration correction during designing may become difficult, or an effective diameter of a lens or mirror, with respect to an entrance pupil diameter, becomes considerably larger, which increases the size of the device.

With the foregoing in view, it is an object of the present invention to provide an infrared image capture device which, although having an objective optical system including, near the optical axis, a non-transmitting portion where light from the object does not pass, can prevent entry of infrared ray, which comes from an area other than the object and is not desirable for imaging, into the infrared detector, by using a non-special simple cold aperture with a circular aperture area in an aperture-matched state, without increasing the size of the device.

### Means to Solve the Problems

To achieve this object, an aspect of the present invention provides an infrared image capture device having: an infrared optical system that collects infrared ray from an object; an infrared image sensor that receives infrared ray from the infrared optical system; and a cold aperture that prevents entry of infrared ray, which comes from an area other than the object and is not desirable for imaging, into the infrared image sensor, wherein the infrared optical system includes: an objective optical system that includes a primary mirror and an auxiliary mirror disposed to face each other along an optical axis, and forms an intermediate image of the object by sequentially reflecting the infrared ray from the object using the primary mirror and the auxiliary mirror; and a re-imaging system that forms the intermediate image formed by the objective optical system again on the infrared image sensor, a non-transmitting portion which does not transmit the infrared ray from the object exists in the center portion of the auxiliary mirror, and the center portion of the auxiliary mirror corresponding to the non-transmitting portion is formed in a concave surface which satisfies a following conditional expression:

L/1.2<R<1.5L, where R denotes the absolute value of a radius of curvature of the center portion of the auxiliary mirror which corresponds to the non-transmitting portion, and L denotes a distance from the intermediate image forming position to the center portion of the auxiliary mirror which corresponds to the non-transmitting portion.

### Advantageous Effects of the Invention

The present invention can provide an infrared image capture device which, although having an objective optical system including, near the optical axis, a non-transmitting portion, where light from the object does not pass, can prevent entry of infrared ray, which comes from an area other than the object and is not desirable for imaging, into the infrared detector, by using a non-special simple cold aperture with a circular aperture area in an aperture-matched state, without increasing the size of the device.

### BRIEF DESCRIPTION OF THE DRAWINGS

FIG. 1 is a diagram depicting an infrared image capture device (having a Cassegrain type objective optical system) according to the present embodiment, and shows a cross-sectional configuration thereof, and an optical path of a zonal luminous flux generated due to the aperture of the primary mirror;

FIG. 2 is a diagram of the infrared image capture device according to this embodiment, depicting a shape of an auxiliary mirror and a state of reflection of an axial luminous flux from the portion located in the center portion of the auxiliary mirror through which infrared rays from the object cannot be transmitted;

FIG. 3 is a diagram depicting the infrared image capture device according to this embodiment, and shows an optical path of luminous flux in the center portion of the aperture;

FIG. 4 is a diagram depicting an infrared image capture device (having a Cassegrain type objective optical system) according to Embodiment 2, and shows a cross-sectional configuration thereof, and an optical path of a zonal luminous flux generated due to the aperture of the primary mirror;

FIG. 5 is a diagram of the infrared image capture device according to Embodiment 2, depicting a shape of an auxiliary mirror and a state of reflection of an axial luminous flux from the portion located in the center portion of the auxiliary mirror through which infrared rays from the object cannot be transmitted;

FIG. 6 is a diagram depicting the infrared image capture device according to Embodiment 2, and shows an optical path of luminous flux in the center portion of the aperture;

FIG. 7 is a diagram depicting an infrared image capture device according to Embodiment 3, and shows an optical path of luminous flux that is not shielded by the spider;

FIG. 8 is a diagram depicting the infrared image capture device according to Embodiment 3, and shows a cross-sectional view of an aperture of a lens barrel viewed from the object side;

FIG. 9 is a diagram depicting the infrared image capture device according to Embodiment 3, and shows an optical path of luminous flux shielded by the spider in this device;

FIG. 10 is a diagram depicting an infrared image capture device of a comparison example where aperture matching has been performed, and a portion not transmitting infrared ray from the object exists in a center portion of an auxiliary mirror, and shows an optical path of a zonal luminous flux generated due to the aperture of the primary mirror; and

FIG. 11 is a diagram depicting an infrared image capture device of a comparison example where aperture matching has been performed, and a portion not transmitting infrared ray from the object exists in the center portion of the auxiliary mirror, and shows an optical path of the luminous flux in the center portion of the aperture.

### DESCRIPTION OF THE EMBODIMENTS

Embodiments of the present invention will now be described with reference to the drawings. To clarify description, the radius of curvature of the auxiliary mirror 12 is exaggerated for all drawings.

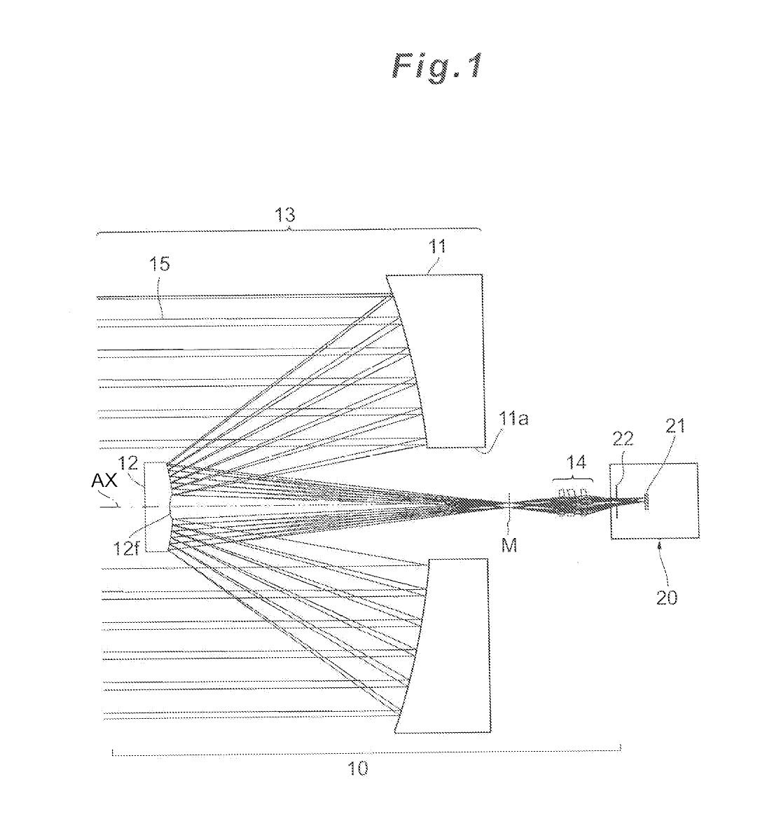

An infrared image capture device according to the present embodiment has an infrared optical system 10 and an infrared detector 20, as illustrated in FIG. 1.

The infrared, optical system 10 is for collecting heat radiated from an object (not illustrated), that is infrared ray, and includes a primary mirror 11 and an auxiliary mirror 12 which are disposed to face each other along an optical axis AX. The infrared optical system 10 also includes an objective optical system 13 that forms an intermediate image of the object by sequentially reflecting the infrared ray from the object using the primary mirror 11 and the auxiliary mirror 12, and a re-imaging optical system 14 that forms the intermediate image formed by the objective optical system 13 again on an infrared image sensor 21 (in the infrared detector 20).

The infrared detector 20 is disposed in a position where infrared ray from the object is collected by the infrared optical system 10, and includes: the infrared image sensor 21 that receives infrared ray from the infrared optical system 10; a cold aperture 22 that is disposed between the infrared optical system 10 and the infrared image sensor 21, for preventing entry of undesirable infrared ray that comes from an area around an imaging surface (on the side and diagonal direction) of the infrared image sensor 21; and a cooling device (not illustrated) that cools inside the infrared detector 20 and the infrared image sensor 21 down to a low temperature (e.g. around temperature of liquid nitrogen), so as to minimize infrared ray self-irradiating from these units.

The cold aperture 22 has a simple circular aperture in the center portion, and is designed such that the position and a size of the aperture match with the position and the size (diameter) of an exit pupil of the infrared optical system 10 (re-imaging optical system 14), in other words, such that aperture matching can be performed. By performing aperture matching like this, entry of infrared ray, which comes from an area other than the object and is not desirable for imaging, to the infrared detector 20, can be efficiently prevented, and a good infrared image of the object can be acquired.

In the infrared image capture device having the above configuration, an intermediate image of the object is formed by sequentially reflecting the heat (infrared ray) irradiated from the object using the primary mirror 11 and the auxiliary mirror 12 constituting the objective optical system 13, and a thermal image (infrared image) of the object is acquired by collecting and imaging the light from the intermediate image again on the infrared image sensor 21 using the re-imaging optical system 14 (via the cold aperture 22).

The objective optical system 13 is a so called “Cassegrain type optical system” constituted by the primary mirror 11, which is a concave reflecting mirror having an aperture 11a in the center portion (having a concave surface facing the auxiliary mirror 12), and the auxiliary mirror 12, which is a convex reflecting mirror (having a convex surface facing the primary mirror 11). In this case, the luminous flux from the primary mirror 11 to the auxiliary mirror 12 becomes a zonal luminous flux 15 due to the aperture 11a of the primary mirror 11, hence a portion where the luminous flux from the object does not exist is formed in an area near the optical axis AX. In other words, a non-transmitting portion 12f, where infrared ray from the object does not transmit, exists in the center portion of the auxiliary mirror 12 (zonal luminous flux 15), as mentioned above.

Therefore according to this embodiment, the non-transmitting portion 12f that exists in the center portion of the auxiliary mirror 12 is formed in a concave surface which satisfies a following conditional expression (1). In other words, the reflecting surface of the auxiliary mirror 12 has two different forms: the concave reflecting surface 12f and the convex reflecting surface 12A.

L/1.2<R<1.5L (1)

where R denotes the absolute value of the radius of curvature of the center portion of the auxiliary mirror 12 which corresponds to the non-transmitting portion 12f, and L denotes a distance from the intermediate image forming position M to the center portion of the auxiliary mirror 12 which corresponds to the non-transmitting portion 12f.

To make the effect caused by satisfying the conditional expression (1) better, it is preferable that the lower limit value is L/1.1. Furthermore, to make the effect caused by satisfying the conditional expression (1) better, it is preferable that the upper limit value is 1.2L.

Ideally the non-transmitting portion 12f that exists in the center portion of the auxiliary mirror 12 is formed in a concave surface of which center of curvature is at the position M where the intermediate image is formed by the objective optical system 13 (not illustrated) on the optical axis AX (in other words, a concave surface of which radius of curvature is the distance L from the center M₀ of the optical axis of the auxiliary mirror 12 to the position M where the intermediate image is formed by the objective optical system 13 (∴ R L)). In this embodiment, R=L=600 mm.

The non-transmitting portion 12f in the concave surface of the auxiliary mirror 12 is disposed in a position that is conjugate with the exit pupil of the infrared optical system 10 (re-imaging optical system 14). As mentioned above, the position of the exit pupil of the infrared optical system 10 (re-imaging optical system 14) matches with the position of the cold aperture 22, hence the non-transmitting portion 12f in the concave surface of the auxiliary mirror 12 is also conjugate with the cold aperture.

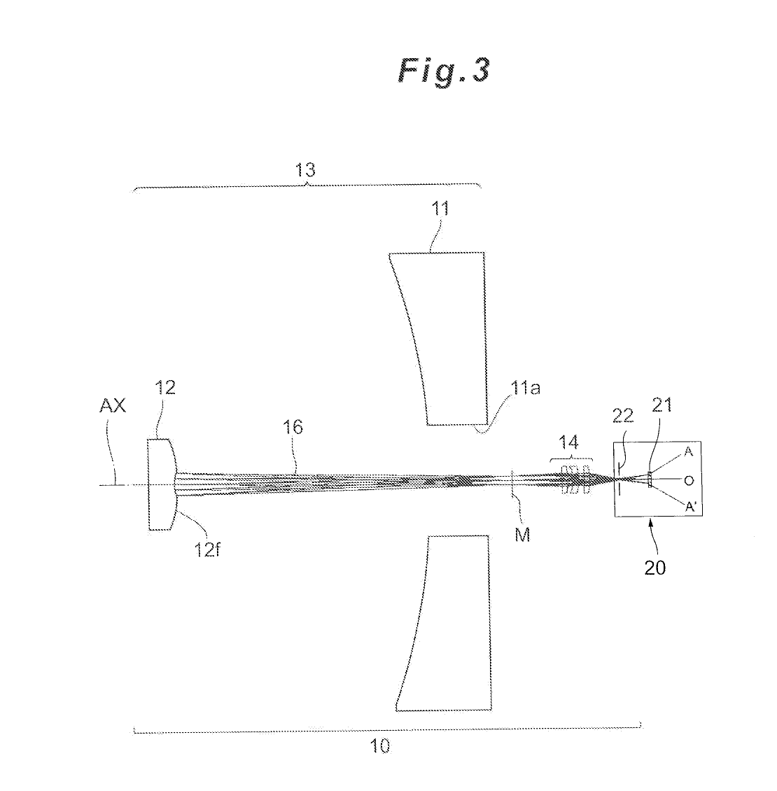

Since the center portion of the auxiliary mirror 12, which is a convex mirror, has this special shape, the luminous flux (axial luminous flux) 16 that passes through the center portion of the aperture 11a of the primary mirror 11 is reflected on the non-transmitting portion 12f in the concave surface of the auxiliary mirror 12, and returns to the center portion of the aperture 11a. Therefore the optical path of the luminous flux in the center portion of the aperture 11a becomes as illustrated in FIG. 3, and a ray emitted from the center point O of the imaging surface of the infrared image sensor 21 is reflected on the non-transmitting portion 12f in the concave surface of the auxiliary mirror 12, and returns to the point O, and the ray emitted from a point. A on the imaging surface is reflected by the non-transmitting portion 12f in the concave surface of the auxiliary mirror 12, and returns to a point A′, which is symmetric with the point A with respect to the optical axis. In other words, the luminous flux existing in the center portion of the aperture 11a forms an image of the imaging surface itself of the infrared image sensor 21 by the reflection on the non-transmitting portion 12f in the concave surface of the auxiliary mirror 12.

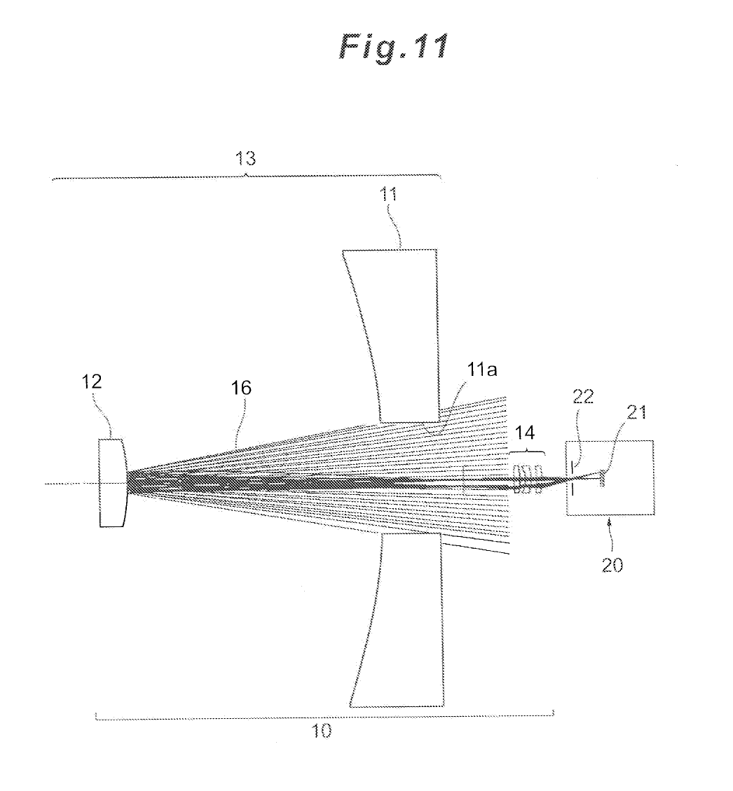

Therefore unlike an optical system of a comparison example in FIG. 11 to be described later, all the luminous flux in the center portion of the aperture 11a is generated from inside the infrared detector 20 (not irradiated from the primary mirror 11 or the peripheral lens barrel area thereof). However the inside of the infrared detector 20 is cooled down to a very low temperature by the cooling device (not illustrated), as mentioned above, hence undesired infrared ray from the center portion of the aperture 11a is not detected.

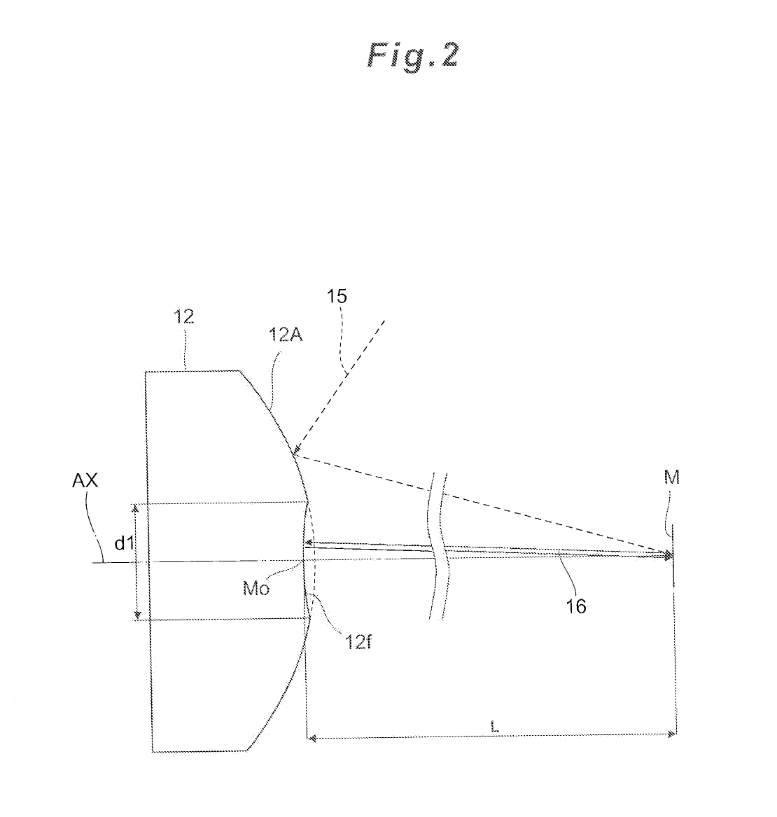

The size of the diameter of the non-transmitting portion 12f in the concave surface of the auxiliary mirror 12 (this size is denoted with d1, see FIG. 2) can be determined by d1=d2×(D1/D2), where D1 denotes the aperture size of the aperture 11a of the primary mirror 11, D2 denotes an effective diameter of the primary mirror 11 and d2 denotes an effective diameter of the auxiliary mirror 12. As this embodiment shows, if the non-transmitting portion 12f of the auxiliary mirror 12 and the cold aperture 22 are disposed to be conjugate with each other, then the size of the diameter d1 of the non-transmitting portion 12f becomes the minimum, and the ratio of the non-transmitting portion 12f with respect to the entire reflecting surface of the auxiliary mirror 12 can be minimized.

According to the infrared image capture device of the present embodiment, as described above, the non-transmitting portion 12f in the center portion of the auxiliary mirror 12, where infrared ray from the object does not transmit, is formed in the concave surface, whereby entry of undesired infrared ray that comes from the non-transmitting portion 12f into the infrared image sensor 21 can be prevented, and only infrared ray that comes from the object can be allowed to enter into the infrared image sensor 21. As a result, noise that enters the infrared detector 20 can be suppressed, and detection sensitivity of the infrared detector 20 can be improved.

The present invention is not limited to Embodiment 1, but numerous developments are possible. In the description hereinbelow, a composing element that is the same as or has a function equivalent to a composing element used for the infrared image capture device according to Embodiment 1 is denoted with the same reference symbol as Embodiment 1, and description thereof is omitted.

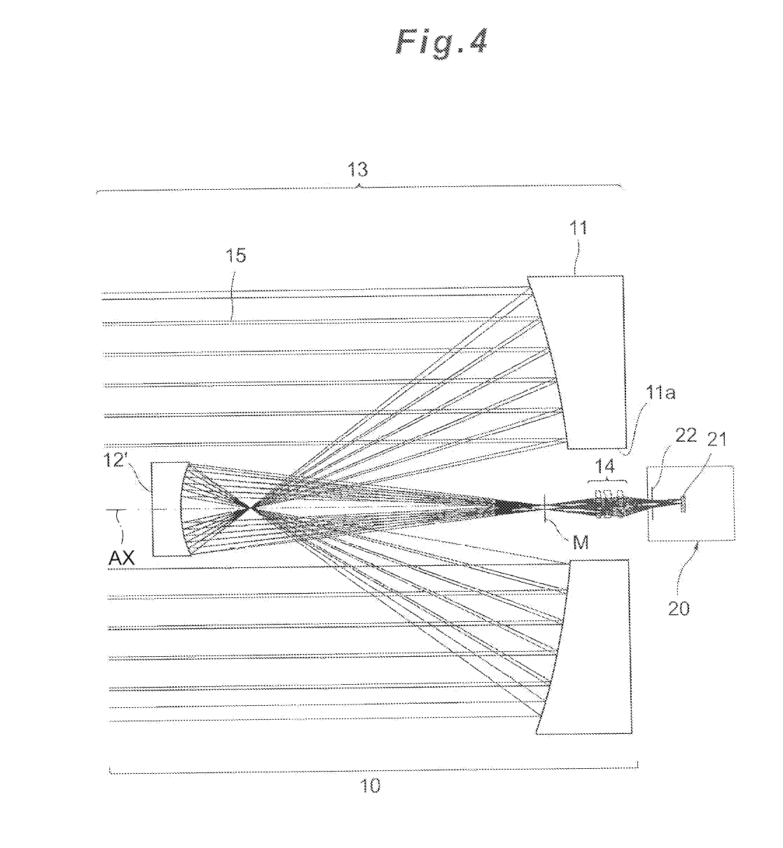

Now an infrared image capture device according to Embodiment 2 will be described with reference to FIG. 4 to FIG. 6. For example, in Embodiment 1, the objective optical system 13 is the Cassegrain type optical system where the auxiliary mirror 12 is a convex mirror, but as FIG. 4 illustrates, the objective optical system 13 of the infrared image capture device according to Embodiment 2 can be a Gregorian type optical system where the auxiliary mirror 12′ is a concave mirror. In this case, an essentially same infrared image capture device as Embodiment 1 can be acquired.

In the case of using the Gregorian type optical system as well, the luminous flux from the primary mirror 11 to the auxiliary mirror 12 becomes a zonal luminous flux 15 due to the aperture 11a of the primary mirror 11, hence a portion where the luminous flux from the object does not exist is formed in an area near the optical axis AX. In other words, a non-transmitting portion 12f′, where infrared ray from the object does not transmit, exists in the center portion of the auxiliary mirror 12′ (zonal luminous flux 15, as mentioned above).

Here just like Embodiment 1, the non-transmitting portion 12f′, that exists in the center portion of the auxiliary mirror 12′, is formed in a concave surface which satisfies the following conditional expression (1)′. In other words, the reflecting surface of the auxiliary mirror 12′ has two different concave surfaces: 12f′ and 12B, that have different radius of curvatures.

L′/1.2<R′<1.5L′ (1)′

where R′ denotes the absolute value of the radius of curvature of the center portion of the auxiliary mirror 12′ which corresponds to the non-transmitting portion 12f′, and L′ denotes a distance from the intermediate image forming position M to the center portion of the auxiliary mirror 12′ which corresponds to the non-transmitting portion 12f′.

To make the effect caused by satisfying the conditional expression (1)′ better, it is preferable that the lower limit value is L′/1.1. Furthermore, to make the effect caused by satisfying the conditional expression (1)′ better, it is preferable that the upper limit value is 1.2L′.

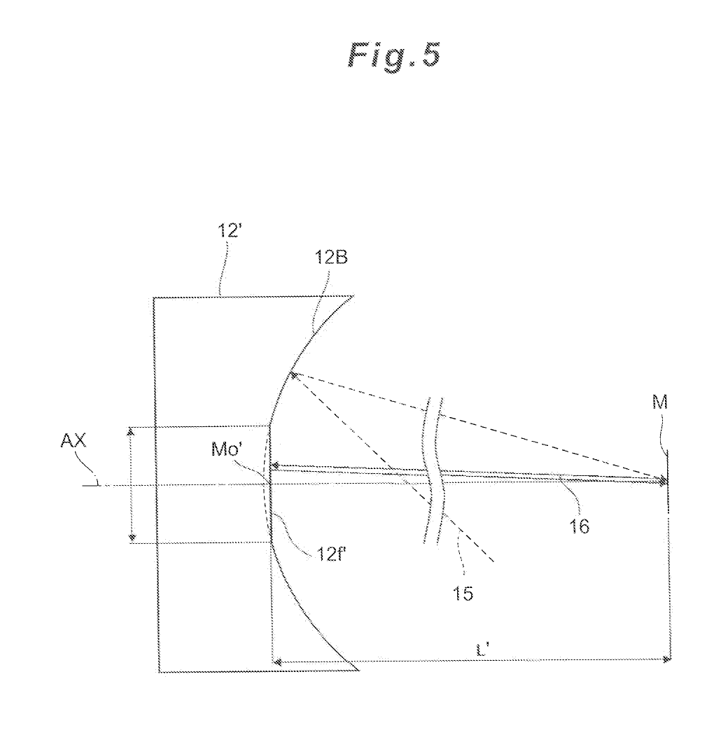

Ideally, as illustrated in FIG. 5, the non-transmitting portion 12f′ that exists in the center portion of the auxiliary mirror 12′ is formed in a concave surface of which center of curvature is in the position M, where the intermediate image is formed by the objective optical system 13 (not illustrated) on the optical axis AX (in other words, a concave surface of which radius of curvature is the distance L′ from the center M₀′ of the optical axis of the auxiliary mirror 12′ to the position M where the intermediate image is formed by the objective optical system 13 (∴ R′=L′)). In this embodiment, R′=L′=600 nm.

The non-transmitting portion 12f′ in the concave surface of the auxiliary mirror 12′ is disposed in a position that is conjugate with the exit pupil of the infrared optical system 10 (re-imaging optical system 14). The position of the exit pupil of the infrared optical system 10 (re-imaging opt system 10 (re-imaging optical system 14) matches with the position of the cold aperture 22, hence the non-transmitting portion 12f′ in the concave surface of the auxiliary mirror 12f′ is also conjugate with the cold aperture 22.

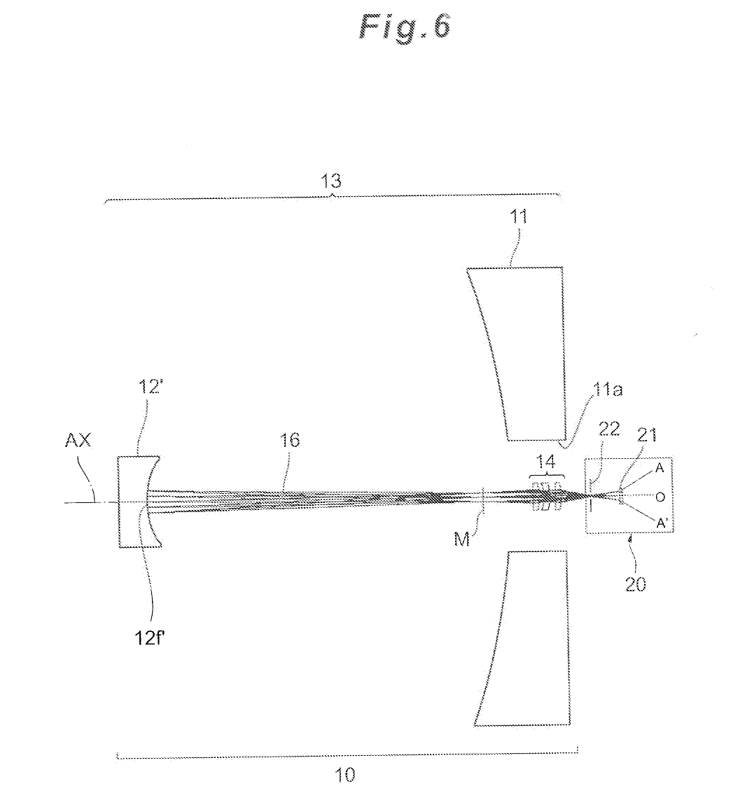

Since the center portion of the auxiliary mirror 12′ has this special shape, the luminous flux (axial luminous flux) 16 that passes through the center portion of the aperture 11a of the primary mirror 11 is reflected on the non-transmitting portion 12f′ in the concave surface of the auxiliary mirror 12′, and returns to the center portion of the aperture 11a. Therefore the optical path of the luminous flux in the center portion of the aperture 11a becomes as illustrated in FIG. 6, and a ray emitted from the center point O of the imaging surface of the infrared image sensor 21 is reflected on the non-transmitting portion 12f′ in the concave surface of the auxiliary mirror 12′, and returns to the point O, and the ray emitted from the point A on the imaging surface is reflected on the non-transmitting portion 12f′ in the concave surface of the auxiliary mirror 12′, and returns to a point A′, which is symmetric with the point A with respect to the optical axis. In other words, the luminous flux existing in the center portion of the aperture 11a forms an image of the imaging surface itself of the infrared image sensor 21 by the reflection on the non-transmitting portion 12f′ in the concave surface of the auxiliary mirror 12′.

Therefore all the luminous flux of the center portion of the aperture 11a is generated from inside the infrared detector 20, but inside the infrared detector 20 is cooled down to a very low temperature by the cooling device (not illustrated), hence undesired infrared ray from the center portion of the aperture 11a is not detected. Therefore a similar effect as the infrared image capture device of Embodiment 1 can be acquired.

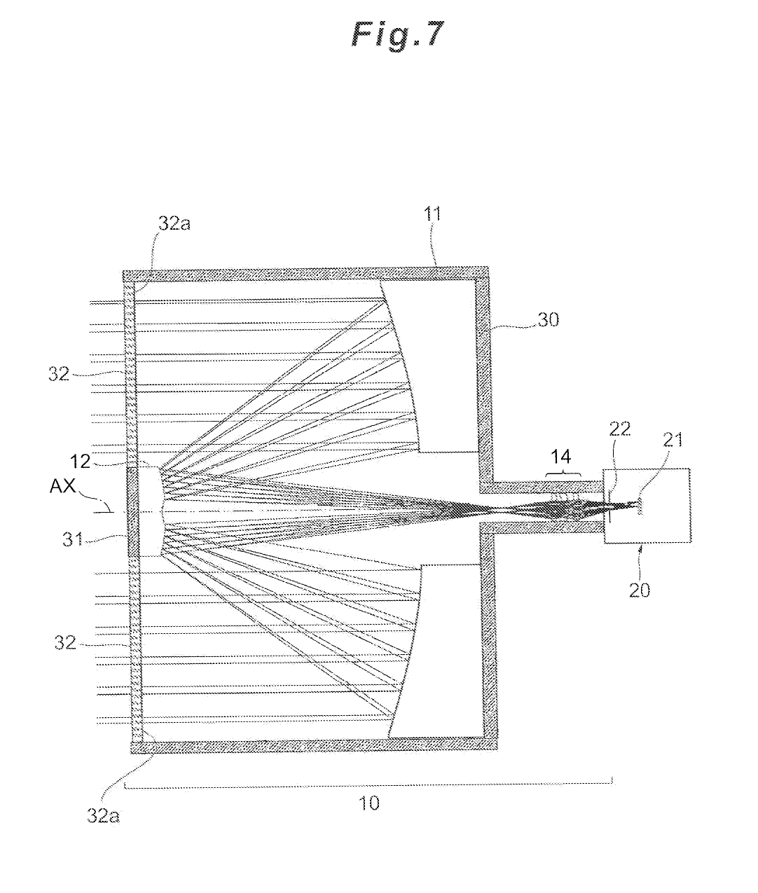

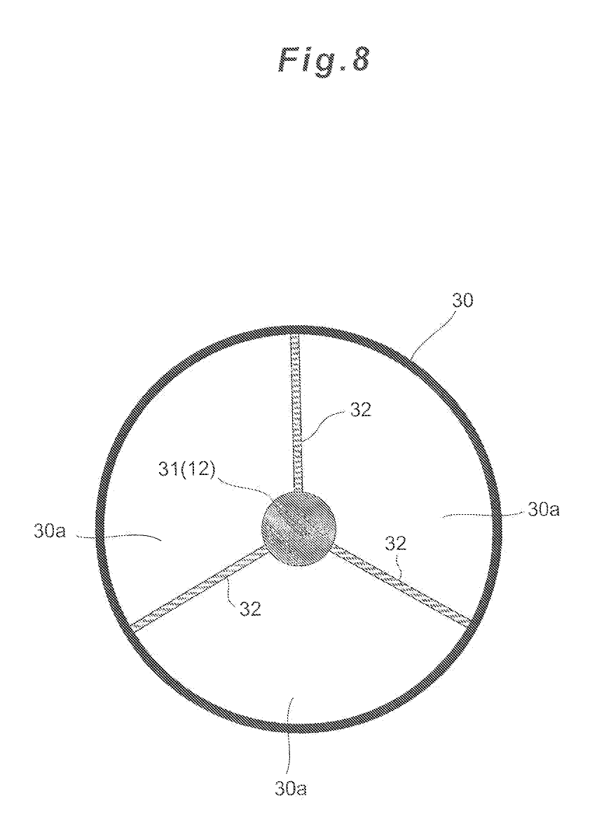

Now an infrared image capture device according to Embodiment 3 will be described with reference to FIG. 7 to FIG. 9. As illustrated in FIG. 7 and FIG. 8, the infrared image capture device according to this embodiment is housed in a lens barrel 30 in which an aperture 30a is formed on one end to guide the infrared ray from an object (not illustrated) to the infrared optical system 10. The auxiliary mirror 12 is supported in the lens barrel 30 by spiders 32 which radiate out from a pedestal 31 for securing the auxiliary mirror 12.

In the infrared image capture device 1, where the non-transmitting portion 12f in the concave surface exists in the center portion of the auxiliary mirror 12, as mentioned above, undesired infrared ray in the center portion of the aperture 11a does not enter the infrared detector 20. However, as illustrated in FIG. 8, the spiders 32 also shield the luminous flux, and entry of undesired infrared ray from the spiders 32 becomes a problem.

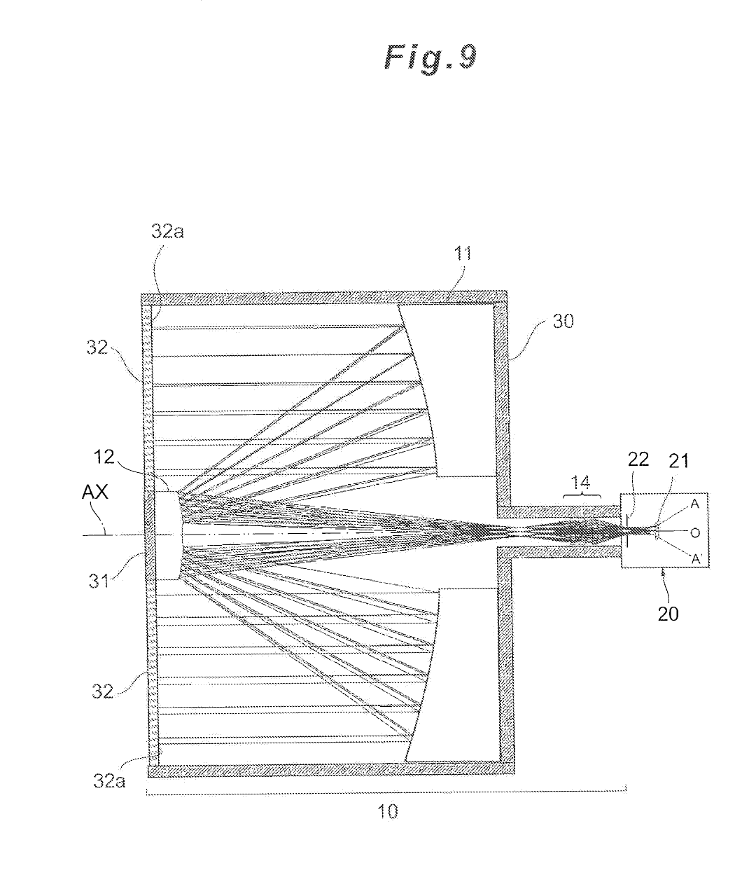

In order to solve this problem, it is preferable that the spider 32 is a plane of which outer surface 32a facing the primary mirror 11 is perpendicular to the optical axis AX, and is constituted by a mirror surface having a high reflectance to infrared ray. In the present embodiment, the spider 32 is a plane parallel plate of which each face is disposed in a direction to orthogonally intersect the optical axis AX of the primary mirror 11, and the outer surface 32a facing the primary mirror 11 is a mirror surface having a high reflectance to infrared ray. According to this configuration, the optical path of the luminous flux shielded by the spider 32 becomes as illustrated in FIG. 9, where a ray emitted from the center point O of the imaging surface of the infrared image sensor 21 is reflected by the mirror surface 32a of the spider 32 facing the primary mirror 11 via the auxiliary mirror 12 and the primary mirror 11 sequentially, and then returns to the point O via the primary mirror 11 and the auxiliary mirror 12 sequentially. A ray emitted from the point A on the imaging surface as well is reflected by the mirror surface 32a of the spider 32 facing the primary mirror 11 via the auxiliary mirror 12 and the primary mirror 11 sequentially, and then returns to the point A′, which is symmetric with the point A with respect to the optical axis, via the primary mirror 11 and the auxiliary mirror 12 sequentially. In other words, the luminous flux shielded by the spider 32 forms an image of the imaging surface itself of the infrared image sensor 21 by being reflected by the mirror surface 32a of the spider 32 facing the primary mirror 11.

Therefore just like the above mentioned luminous flux in the center portion of the aperture 11a, all the luminous flux shielded by the spider 32 is generated inside the infrared detector 20. However undesired infrared ray generated by the spider 32 is not detected, since inside of the infrared detector 20 is cooled down to a very low temperature by the cooling device (not illustrated), as mentioned above.

As described above, the present invention can provide an infrared image capture device which, although having an objective optical system including, near the optical axis, a non-transmitting portion where light from the object does not pass, can prevent entry of undesired infrared ray from the non-transmitting portion into the infrared detector and exhibits satisfactory detection sensitivity, by forming the center portion of the auxiliary mirror corresponding to the non-transmitting portion into a concave surface by using a non-special simple cold aperture with a circular aperture area in an aperture-matched state, without increasing the size of the device.

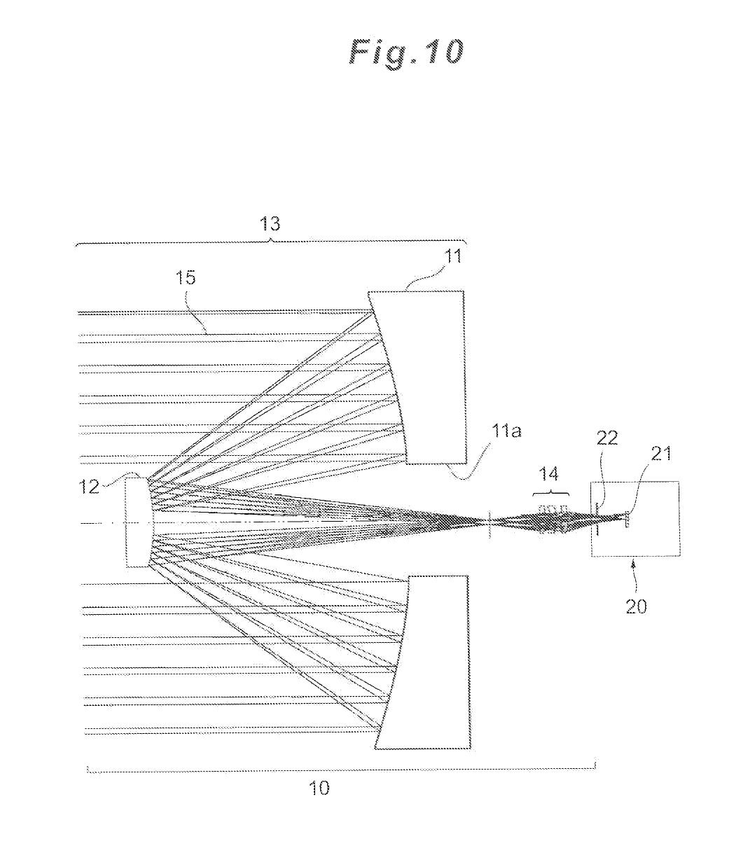

Now an infrared image capture device of a comparison example will be described for comparison. As illustrated in FIG. 10, the infrared image capture device of the comparison example is basically constituted by an infrared optical system 10 and an infrared detector 20. The infrared optical system 10 has an objective optical system 13 and a re-imaging optical system 14, collects heat irradiated from an object (not illustrated), that is infrared ray, and forms an image on an image sensor 21 of the infrared detector 20. The infrared detector 20 is disposed in a position where the infrared ray from the object is collected by the infrared optical system 10, and includes a plurality of light receiving elements on the image sensor surface 21.

In this infrared image capture device, a cold aperture 22 is disposed in the infrared detector 10, between the infrared optical system 10 and the infrared image sensor 21, and the cold aperture 22 has an aperture portion to allow infrared ray collected by the infrared optical system 10 to pass, in order to eliminate the influence of infrared ray (e.g. self-radiation of the lens barrel), which comes from an area other than the object and is not desirable for imaging, so that the undesired light from an area around (on the side and diagonal direction) of the image sensor surface 21 is shielded, and at the same time, the cold aperture 22 and the infrared detector 20 are cooled down to a low temperature (around the temperature of liquid nitrogen), to minimize infrared ray self-irradiating from these units.

The aperture portion of the cold aperture 22 is designed so as to match with the position and the size (diameter) of the exit pupil of the infrared optical system 10, and this state is normally called an “aperture-matched state”. By matching the aperture of the cold aperture 22 with the exit pupil of the infrared optical system 10 like this, infrared ray, which comes from an area other than the object and is not desirable for imaging, can be efficiently prevented in the infrared optical system 10, and only infrared ray of the object can be acquired by the infrared detector 20.

However if a Cassegrain type objective optical system 13, constituted by a primary mirror 11 having an aperture 11a in the center portion and an auxiliary mirror 12 for directing infrared ray reflected by the primary mirror 11 to the aperture 11a of the primary mirror 11, is used for the infrared optical system 10, the infrared ray from the object reflected by the primary mirror 11 becomes ring-shape luminous flux 15 due to the aperture 11a of the primary mirror 11. In other words, as illustrated in FIG. 11, the luminous flux (axial luminous flux) 16 in the center portion of the aperture 11a is infrared ray which is irradiated from an area other than the object, that is an aperture 11a of the primary mirror 11 and the peripheral area thereof, and is not desirable for imaging. Thus even if the aperture matching has been performed, the S/N (signal-to-noise) ratio of the acquired image deteriorates if undesirable infrared ray enters into the center portion of the aperture 11a, since the mixed infrared ray is detected as noise.

The amount of detection noise like this differs depending on the angle of view of the luminous flux. The ratio of the detection noise on the optical axis is high if the source is inside the infrared detector 10, but according to the infrared image capture device, the infrared detector 10 is cooled down and undesired infrared ray is minimized, as mentioned above, hence the detection noise tends to lessen compared with the case of a luminous flux having an off-axis angle of view. As a result, a gradient is generated in the detection noise level between the center portion and the peripheral portion of the infrared detector 20, and a vague image of the cold aperture 22 may appear in the center portion of the image sensor surface 21 (the so called “narcissus effect”).

In the case of the infrared image capture device according to the present embodiment, on the other hand, even if the objective optical system including a non-transmitting portion is provided, entry of undesired infrared ray from the non-transmitting portion into the infrared detector is prevented, and an image with good S/N can be acquired by forming the center portion of the auxiliary mirror into the concave surface, in the aperture-matched state as mentioned above.

### EXPLANATION OF NUMERALS AND CHARACTERS

1 infrared image capture device
10 infrared optical system
11 primary mirror
11a aperture of primary mirror
12 auxiliary mirror
12f non-transmitting portion of center portion of auxiliary mirror
13 objective optical system
14 re-imaging optical system
20 infrared detector
21 infrared image sensor
22 cold aperture
30 lens barrel
30a aperture of lens barrel
31 pedestal
32 spider
AX optical axis

1. An infrared image capture device, comprising:
an infrared optical system that collects infrared ray from an object;
an infrared image sensor that receives infrared ray from the infrared optical system; and
a cold aperture that prevents entry of infrared ray, which comes from an area other than the object and is not desirable for imaging, into the infrared image sensor,
the infrared optical system including: an objective optical system that includes a primary mirror and an auxiliary mirror disposed to face each other along an optical axis, and forms an intermediate image of the object by sequentially reflecting the infrared ray from the object using the primary mirror and the auxiliary mirror; and a re-imaging system that forms the intermediate image formed by the objective optical system again on the infrared image sensor,
a non-transmitting portion which does not transmit the infrared ray from the object existing in the center portion of the auxiliary mirror, and
the center portion of the auxiliary mirror corresponding to the non-transmitting portion being formed in a concave surface which satisfies a following conditional expression:
L/1.2<R<1.5L
where R denotes the absolute value of a radius of curvature of the center portion of the auxiliary mirror which corresponds to the non-transmitting portion, and L denotes a distance from the intermediate image forming position to the center portion of the auxiliary mirror which corresponds to the non-transmitting portion.

2. The infrared image capture device according to claim 1, wherein
the center portion of the auxiliary mirror which corresponds to the non-transmitting portion is formed in a concave surface of which center of curvature is the intermediate image forming position on the optical axis used by the objective optical system.

3. The infrared image capture device according to claim 1, wherein
the non-transmitting portion of the auxiliary mirror is conjugate with an exit pupil of the infrared optical system.

4. The infrared image capture device according to any one of claim 1, wherein
the position of an exit pupil of the infrared optical system matches with the position of the cold aperture.

5. The infrared image capture device according to any one of claim 1, wherein
the infrared image capture device is housed in a lens barrel in which an aperture is formed on one end to guide the infrared ray from the object to the infrared optical system,
the lens barrel has a spider in the aperture in order to securely hold the auxiliary mirror, and
the spider is a plane of which outer surface facing the primary mirror is perpendicular to the optical axis, and is constituted by a mirror surface having a high reflectance to infrared ray.
